(19) United States
(12) Patent Application Publication
(10) Pub. No.: US 2014/0156559 A1
(43) Pub. Date: Jun. 5, 2014

(54) TRANSACTIONAL DECISION MAKING DEVICE AND METHOD

(71) Applicant: iJoin Solutions, LLC, Raleigh, NC (US)

(72) Inventor: Fred Greenstein, Santa Rosa, CA (US)

(73) Assignee: iJoin Solutions, LLC, Raleigh, NC (US)

(21) Appl. No.: 14/172,361

(22) Filed: Feb. 4, 2014

Related U.S. Application Data
(63) Continuation of application No. 12/407,083, filed on Mar. 19, 2009.
(60) Provisional application No. 61/038,678, filed on Mar. 21, 2008.

(51) Int. Cl. G06Q 40/06

(52) U.S. Cl. CPC G06Q 40/06; G06Q 40/02
USPC 705/36 R

(57) ABSTRACT

A system for assisting groups of individuals in making personal and private transactions deploys a common large display means and a plurality of small portable data access and display devices for receiving and viewing private information associated with the matter shown on the common display. The small portable devices access existing transactional websites. The device and the associated method can be used for investment education and transaction execution, as well as enrollment in financial, health and related service plans requiring the user's selection from among options that depend on individual and generally private circumstances, and in particular for retirement plan enrollment and investment management.

### CROSS REFERENCE TO RELATED APPLICATIONS

This application is a continuation of and claims priority to U.S. patent application Ser. No. 12/407,083, filed Mar. 19, 2009, which claims priority to the US Provisional Patent Application titled “Transactional Training Device and Method”, which was filed on Mar. 21, 2008, having application Ser. No. 61/038,678, and which is incorporated herein by reference.

### BACKGROUND OF INVENTION

The present invention relates to a device and method for assisting in financial planning and investment.

Most employees in the United States, and elsewhere, cannot afford to retire strictly on social security benefits paid by the government. While in previous generations many private sector employees received defined benefit pension income after a number of years of service, this practice has largely been supplanted by employers making defined periodic contribution to a retirement plan, which the employees are encouraged to supplement with their own pretax savings in a 401(k) plan or the like. Generally, the employees must make both individual contribution decisions, as well as investment risk and allocation decisions from a basket of instruments that may include mutual funds, group annuities, asset allocation portfolios, ETF's, collective trusts, or other managed accounts.

However, it is general consensus among financial planners that most 401(k) participants are not saving enough for retirement and many are not investing their savings effectively. Relatively few individuals are investment savvy and most 401(k) enrollment and participant asset reallocation processes are passive and inefficient. Participants are asked to fill out a form or go to a website on their own when they have time. However, participant compliance with such requests is low, even when matching contributions are available from the employer. Participants that comply usually choose to contribute less to the retirement plan than they should to comfortably retire, and frequently do a poor job of allocating the money they do invest.

The chance of participant success is greatly enhanced when an individual participant is guided through a thoughtful decision process one on one by an advisor or enrollment specialist; but this can be very expensive!

Accordingly, most companies instead offer seminars to employees that introduce the plan features and details, provide enrollment forms and offer generally applicable advice. Despite these forums, retirement plan participation remains low and investment decision-making often ineffective.

Rather than just present information to groups of participants and hope they take action later, an advisor or enrollment specialist can guide groups of participants through enrollment and asset allocation decision-making processes.

A recently introduced improvement has been to offer more specific advice and assistance where meeting participants can actually make enrollment and allocation choices during such a meeting, with the option of exploring different investing scenarios with their own financial data. This is accomplished by providing each participant with a handheld display that includes a general purpose computer (such as pocket PC's) so that they can privately access their own financial and account data and follow the presenter's instructions to the entire audience. While it would be possible to preload each such display device with the private financial data before the meeting, this would be time intensive and involve tracking each device so that it is goes to the correct participant so that privacy of financial and account information is not compromised. Thus, in this recent improvement participant information from record keeping or payroll systems is first downloaded onto a meeting leader's laptop prior to a meeting; then by establishing a local wireless network for communications between pocket PC's and meeting leader's laptop during the meeting each participant receives their private data. After the participants investment decisions and account changes are entered into the pocket PC they must be next logged and later uploaded, first to the presenter's laptop, and then into the record keeping system for final execution.

This system has not been used for reallocating existing investments by the above means because of compliance concerns over SEC rules requiring that participant elections gathered electronically be processed without delay.

Further, the above process is complex and hard to implement, involving difficult data integration and round-tripping issues and concern for data security. The aforementioned wireless solution to date is thus also expensive, taking many months to customize the transaction interface software for each client.

In light of the above deficiencies of the prior art, it is a first object of the invention to provide increased participation in participant-directed group retirement plans, with increased average contributions per participant, resulting in increased asset flow into group retirement plans.

It is another object of the invention to provide an improved means for groups of participants to be guided through a thoughtful decision process by an advisor or enrollment specialist; as such group processes build efficiency into the 401(k) participant enrollment and investment allocation and reallocation processes.

It is a further object of the invention to execute 401(k) plan transaction in such meetings in real time via existing secure transactional infrastructures.

### SUMMARY OF INVENTION

In the present invention, the first object is achieved by providing a device for training comprising: at least one large computer display device for public display of the public portion of a presentation of information, at least a first general purpose computer that is in signal communication with the large computer display, at least one handheld general purpose computer for private access to non-public information that is connected to a computer network, such as the Internet, wherein the users of the at least one handheld computer are able to access private personal information from the Internet that is related to the material displayed on the large computer display controlled by the general purpose computer.

A second aspect of the invention is characterized by a process for decision making in the management of individual finances, the process comprising the steps of: providing at least one large computer display device, at least one first general purpose computer and at least one handheld computer, connecting at least one of each of the hand held computers to a computer network, such as the Internet, accessing private financial information on at least one handheld computer via the wireless Internet connection, displaying instructional and hypothetical financial information on the large computer display device to a public audience, displaying corresponding but user specific actual and projected financial information on each handheld computer using the private financial information of one or more of the users in the public audience via the handheld computer having the wireless connection to the Internet.

The above and other objects, effects, features, and advantages of the present invention will become more apparent from the following description of the embodiments thereof taken in conjunction with the accompanying drawings.

### BRIEF DESCRIPTION OF THE DRAWINGS

FIG. 1 is a schematic diagram of a first embodiment.

FIG. 2 is a schematic cross-sectional elevation of another embodiment.

FIG. 3 schematic diagram of another embodiment.

### DETAILED DESCRIPTION

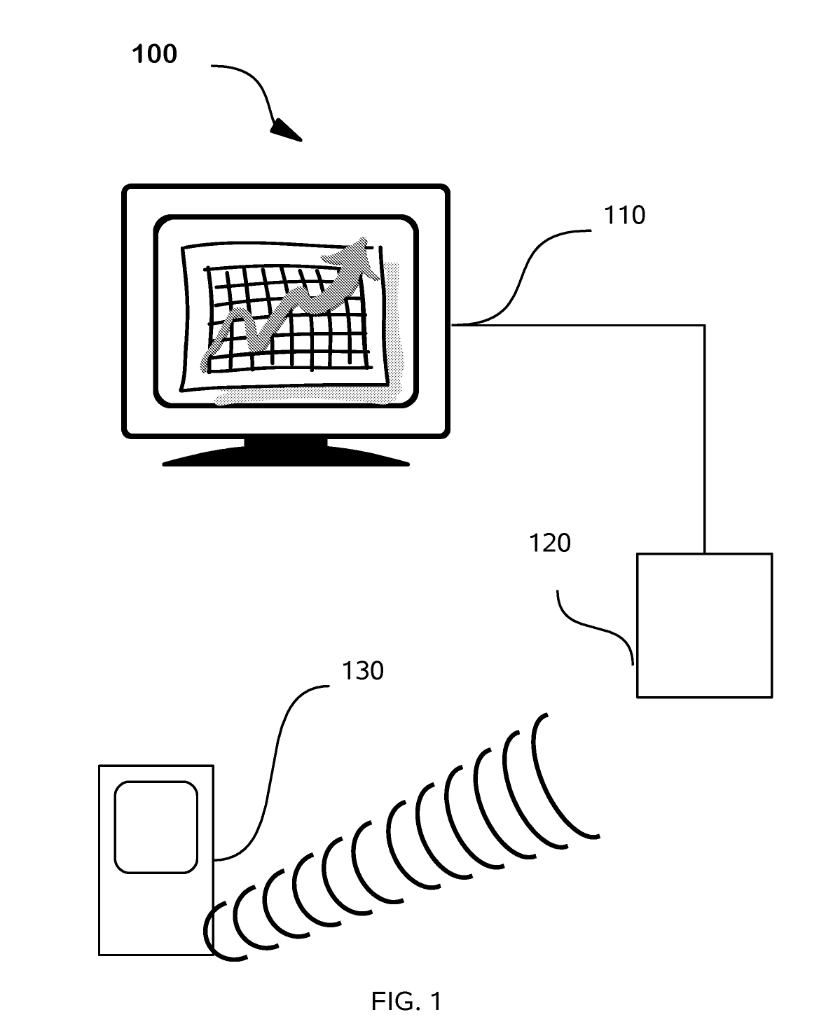

Referring to FIGS. 1 through 3, wherein like reference numerals refer to like components in the various views, there is illustrated therein a new and improved Transactional Decision Making Device, generally denominated 100 herein.

In accordance with the present invention, as shown in FIG. 1, one aspect of the device and method 100 comprises a large computer display device 110 for public display of the public portion of a presentation, at least a first general purpose computer 120 that is in signal communication with the large computer display 110, and at least one handheld general purpose computer 130 for private access to non-public information, which resides on a computer network, which could be aLAN, WAN or the Internet, wherein the user of the handheld computer is able to access private personal information from the computer network or the Internet that is related to the material displayed on the large computer display as controlled by the general purpose computer. The user, having access to the public and education information on the large computer display is better informed and directed in making personal investment decisions directing funds in their private accounting using the handheld computer. The large computer display device 110 is projection display, large flat panel display, such as an LCD or Plasma display or large CRT, but preferably a portable projector.

The first or general purpose computer 120 provides the presentation displayed on the large display device 110, obtaining it either from a server on a LAN, WAN or the Internet, as well as computer readable media collocated with the first computer, such as from memory, hard drive, USB flash drive, portable digital media, such as a CD-ROM, and the like. Alternatively, to the extent that the large display device, as for example an LCD projection, has the ability to read such media directly, the connection to the general purpose computer is optional.

It should be understood that in the alternative embodiments the handheld general purpose computers connect 130 to the Internet via internal cell phone data port, LAN or wireless router or dial up connection and the like. It should also be understood that the handheld general purpose computers 130 is optionally more specifically a handheld organizer/calendar device, Pocket PC, or mobile phone and the like, which includes a small display screen for privacy and at least one human user interface for data input, such as a keypad, keyboard or pen or touch entry tablet. More preferably the display has a privacy screen or other means to limit the viewing angle so it can only be read by the user holding it. Optionally, the device may also include a printer, either as a stand-alone device, built into case 140, the general purpose computer 120 or each mobile device 130 to provide participants written records of their transactions.

Another aspect of the invention enabled by the system 100 in FIGS. 1,2 and 3 is the process of providing the large computer display device 110, a first general purpose computer 120 and at least one handheld computer 130, connecting each of the handheld computers to the Internet, accessing private financial information on the at least one handheld computer 130, displaying instructional and hypothetical financial information on the large computer display device 110, and then displaying corresponding, but user specific actual and projected financial information on each handheld computer using the private financial information of each user. It is most preferred if participants are connected to a provider web site designed for the small screen of the portable or hand held device.

Financial information includes but is not limited to current and projected account balances and asset allocation, personal information on the participants that enables such personal projections, such as age, years to retirement, current savings, savings rate, salary, projected salary increases and company contribution, projected Social Security benefits and the like that are either entered by the user of the handheld computer 130, via a human input interface, such as a keyboard or touchpad, as well as information obtained from a web server on a private LAN, WAN or the Internet. Thus, the small hand held computer 130 is used to access a private account, enter or extract private information to extrapolate future assets during retirement, select from funds and investment vehicles, make present and future allocations of assets as well as to direct periodic payroll deductions to fund such purchases in a 401(k) or related retirement or investment account.

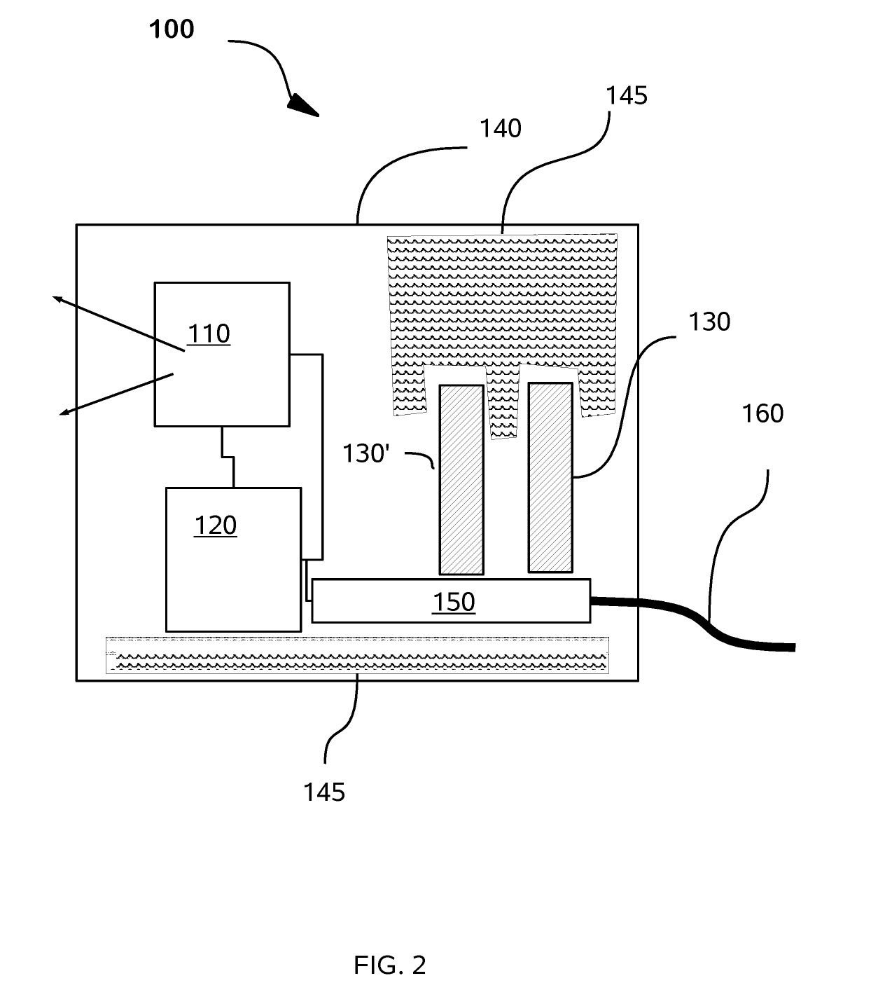

In accordance with a currently more preferred second embodiment of the invention, as shown in FIG. 2, a housing 140 for at least one of the large computer display 110 and the first general purpose computer 120 also contains docking stations 150 to charge at least one, but preferably 10-20 handheld general purpose computers 130 and 130′, etc. An external power cord 160 preferably powers the docking stations 150, the computer display 110 and the first general purpose computer 120. The docking station holds the handheld general purpose computer 130, protects them during transit and also charges their internal batteries, so they are readily available for private access to non-public information via either a LAN, WAN, but preferably the Internet as previously described. The case or cover 140 provides housing for device 100 and itself may integrate protective packaging 145. It should be appreciated that the protective packing 145 is preferably adapted to conform to the shape of the small handheld computers 130 when loaded in docking station 150, thus holding them in communication therewith, as well as protecting them during transit, preferably being formed of a padding material that holds then in place and prevents mechanical shock by absorbing energy. Ideal, all electronic components are protected by such a padding material.

In this more preferred embodiment, the display 110 is preferably a mini-LCD projector.

In alternative embodiments, the housing 140 optionally contains at least one large computer display 110 and preferably a first general purpose computer 120. Alternatively, the housing 140 may contain just one of the large computer display 110, first general purpose computer 120, as well as the plurality of handheld computer 130-130′, etc. and the charging unit/docking station 150 and protective packaging 145.

It is additionally preferably that the docking stations also provide communication signal connections from general purpose computer 120 to each small hand held computer 130, such as for the purpose of testing, preloading information, i.e. website URL's among others, and clearing the memory and records of personal financial information, as well as customizing the display and presentation for different audiences.

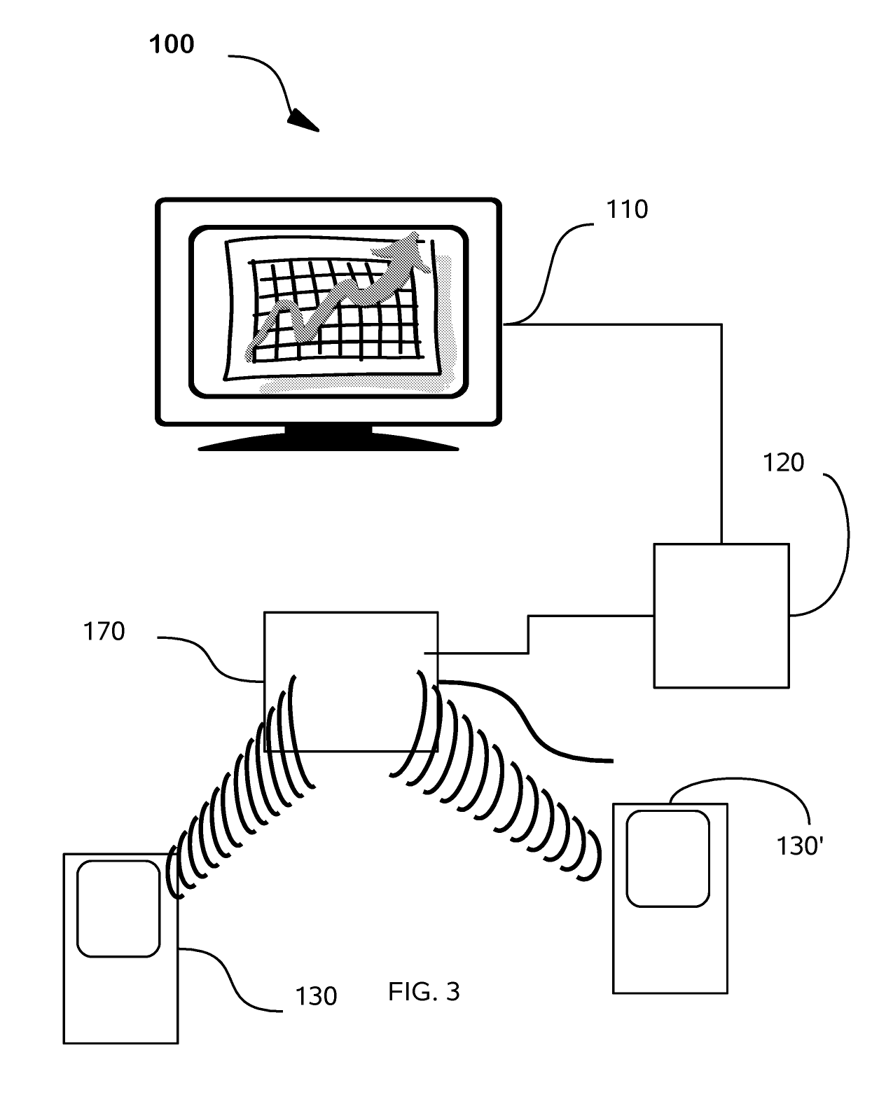

In another embodiment shown in FIG. 3, the connection with the LAN, WAN or Internet is via a wireless router device 170, which preferably, but optionally is in signal communication with the general purpose computer 120 for set up and control and connects to the internet by the either a LAN, WAN, DSL dial up connection or the like as well as a direct wireless connection. Handheld general purpose computer 130, and 130′ are then in signal communication with the wireless router 170 so that each participant can access their plan provider or administrators website during the presentation, decision making and enrollment session.

The embodiment of FIG. 3 has the advantage that the general purpose handheld computing devices 130 can be simpler and less expensive, not requiring any wireless communication other than to the router 170.

As state of the art wireless routers are generally only recommended for connecting no more than about 3 or 4 computers, one of ordinary skill in the art would dismiss the possibility of using such a device to connect the 10-20 handheld computers used by seminar participants.

However, it has been discovered that since the data that needs to be transmitted between the wireless router and each handheld device is relatively small when the handheld devices are used only for this application, commercial wireless routers are suitable.

Further, to avoid the handheld computer from overwhelming the wireless router capacity it is more preferable that the general purpose computer programs the wireless router to limit internet connections to a limited number of URL's associated with financial advice so as to preclude general internet browsing during the seminar. As for example, the limited number of URL's is generally the same as those to be displayed on large computer display, but also allow access to private accounts having a different URL or the same or similar URL “prefix” with a “suffix” identifying the individuals accounts, as well as secure socket layers and other routine security measures.

This provide great economic advantages in that fewer internet access accounts are needed, that is just one for connecting the wireless router to the internet via the handheld or general purpose computer, rather than for each handheld computer used by each participant. Further, a single wireless router can use an existing LAN, WAN hard wire or wireless connection that already exists in a facility.

Accordingly, it should now be appreciated that the present invention eliminates the aforementioned data transfer issues and minimizes the cost of developing and customizing solutions for each employer or plan provider that wishes to use the service to guide and enroll employees in a retirement or other benefit plan.

It should also be appreciated that the 2006 Pension Protection Act encourages computer-modeled financial advice and guidance. As 401(k) Providers have invested a lot of resources and attention to developing quality websites, many web-based financial planning and advice tools are available in the marketplace. The instant invention exploits this infrastructure, and more preferably connects participants to a slimmed down version of provider sites designed for the small screen on handheld computer device 130.

In accordance with the above teachings of the present invention, participants may access their own personal data in order to project the income needed or desired in retirement, and the amount which must be contributed each pay period to reach personal retirement goals.

Anticipated transactions include, but are not limited to those in which participants can enroll and allocate or reallocate investments on the spot. In addition, participants can optionally change participation rates, contribution amounts, and initiate rollovers into 401(k) plans.

As a further benefit to the providers of the seminars, the device 100 and method can be used in another embodiment, pending participant agreement, to gather important data, including detailed contact information and individual demographics. Participants may be asked about other financial services needed (college funding, wealth management, estate planning and insurance). This data can be used to drive targeted follow-up marketing and sales efforts.

Deployment of the present invention and process also complies with SEC and ERISA rules which require that participant elections gathered electronically be processed without delay. Additionally it avoids data transfer and security complexities, as utilizes existing secure transactional websites.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A system for transactional decision making, the system comprising:
a storage module configured to maintain one or more transactional decision making tools for utilizing private financial information associated with a plurality of privately hosted accounts; and
a transactional decision making device that is separate from the storage module and in communication therewith, the transactional decision making device including at least one hardware processor and a memory, wherein the memory stores instructions that when executed by the at least one hardware processor performs the steps comprising:
securely accessing at least a first account of the plurality of privately hosted accounts;
accessing private financial information associated with the first account;
accessing the transactional decision making tools from the storage module; and
performing, in real-time, at least one of a financial transaction or a hypothetical financial transaction associated with the first private account using the transactional decision making tools and at least some of the private financial information.

2. The system of claim 1, wherein the storage module includes a computer, a server, a database, a hard drive, a USB flash drive, or a portable digital media device.

3. The system of claim 1, wherein the transactional decision making device includes a web-enabled device.

4. The system of claim 3, wherein the web-enabled device includes a mobile phone, a personal computer, a personal digital assistant (PDA), a tablet, or a handheld device.

5. The system of claim 1, wherein the transactional decision making device includes a display screen for displaying the financial transaction or the hypothetical financial transaction.

6. The system of claim 1, wherein the transactional decision making tools include extrapolation tools for performing hypothetical financial transactions.

7. The system of claim 1, wherein the transactional decision making tools and private financial information are accessed via the Internet.

8. The system of claim 1, wherein the transactional decision making tools and private financial information are wirelessly accessed.

9. The system of claim 1, wherein the private financial information is associated with an owner of each of the plurality of privately hosted accounts and includes at least one of an account balance, an asset allocation, an age, a number of years until retirement, a savings account balance, a savings rate, a salary, a projected benefit, and/or combinations thereof.

10. The system of claim 1, wherein the transactional decision making tools include computer readable media that, when executed by a hardware processor, project financial information associated with a specific account of the plurality of privately hosted accounts.

11. The system of claim 1, wherein the transactional decision making device includes a user interface whereby an account owner performs the at least one financial transaction or hypothetical financial transaction.

12. The system of claim 1, wherein the transactional decision making device is configured to perform, in real-time, a transaction including enrolling in a retirement account, a college savings account, a pension account, a wealth management account, an estate planning account, an investment account, a 401(k) account, a 403(b) account, a 507 retirement plan, an individual retirement account (IRA), a Roth IRA, or an insurance account.

13. The system of claim 1, wherein the transactional decision making device is configured to perform, in real-time, a transaction including contributing to a retirement account, a college savings account, a pension account, a wealth management account, an estate planning account, an investment account, a 401(k) account, a 403(b) account, a 507 retirement plan, an individual retirement account (IRA), a Roth IRA, or an insurance account.

14. The system of claim 1, wherein the transactional decision making device is configured to perform, in real-time, a transaction including allocating or reallocating investments in a retirement account, a college savings account, a pension account, a wealth management account, an estate planning account, an investment account, a 401(k) account, a 403(b) account, a 507 retirement plan, an individual retirement account (IRA), a Roth IRA, or an insurance account.

15. The system of claim 1, wherein the transactional decision making device is configured to perform, in real-time, a transaction including changing a contribution or deferral rate in a retirement account, a college savings account, a pension account, a wealth management account, an estate planning account, an investment account, a 401(k) account, a 403(b) account, a 507 retirement plan, an individual retirement account (IRA), a Roth IRA, or an insurance account.

16. The system of claim 1, wherein the transactional decision making device is configured to perform, in real-time, a transaction including initiating a rollover into a retirement account, a college savings account, a pension account, a wealth management account, an estate planning account, an investment account, a 401(k) account, a 403(b) account, a 507 retirement plan, an individual retirement account (IRA), a Roth IRA, or an insurance account.

17. A system for transactional decision making, the system comprising:
a storage module configured to maintain instructional information for establishing a plurality of privately hosted accounts; and
a transactional decision making device in communication with the storage module, the transactional decision making device including at least one hardware processor and a memory, wherein the memory stores instructions that when executed by the at least one hardware processor performs the steps comprising:
accessing the instructional tools from the storage module; and
enrolling, in real-time, in at least a first retirement account, a first pension account, or a first 401(k) account of the plurality of accounts using at least some of the instructional information.

18. The system of claim 17, wherein the first retirement account comprises an individual retirement account (IRA) or a Roth IRA.

19. The system of claim 17, wherein the instructional information includes actual financial information, hypothetical financial information, and/or instructional steps for performing guided investment making decisions.

20. The system of claim 17, wherein the storage module includes a computer, a server, a database, a hard drive, a USB flash drive, or a portable digital media device.

21. The system of claim 17, wherein the transactional decision making device includes a web-enabled device.

22. The system of claim 20, wherein the web-enabled device includes a mobile phone, a personal computer, a personal digital assistant (PDA), a tablet, or a handheld device.

23. A method for transactional decision making, the method comprising:
at a transactional decision making device comprising a hardware processor and memory:
communicating with a storage module having instructional information stored thereon for enrolling in a first retirement account of a plurality of privately hosted retirement accounts;
determining one or more parameters of the first retirement account; and
enrolling, in real-time, in the first retirement account using the instructional information obtained from the storage module.

24. The method of claim 23, wherein the storage module and the transactional decision making device communicate wirelessly or via the Internet.

25. The method of claim 23, wherein the first retirement account comprises an individual retirement account (IRA), a Roth IRA, a 401(k) account, a pension account, a 403(b) account, or a 507 retirement plan.

26. The method of claim 23, wherein the instructional information is visually displayed on a display screen.

27. The method of claim 23, wherein determining one or more parameters of the first retirement account includes determining a contribution or deferral rate.

28. The method of claim 23, wherein determining one or more parameters of the first account includes allocating investments.

29. The system of claim 23, wherein the transactional decision making device is a web-enabled device including a mobile phone, a personal computer, a personal digital assistant (PDA), a tablet, or a handheld device.

30. A non-transitory computer readable medium having stored thereon computer executable instructions embodied in a computer readable medium and when executed by a processor of a computer performs steps comprising:
at a transactional decision making device comprising a hardware processor and memory:
communicating with a storage module having instructional information stored thereon for enrolling in a first retirement account of a plurality of privately hosted retirement accounts;
determining one or more parameters of the first retirement account; and
enrolling, in real-time, in the first retirement account using the instructional information obtained from the storage module.
